(19) United States
(12) Patent Application Publication
(10) Pub. No.: US 2004/0220696 A1
(43) Pub. Date: Nov. 4, 2004

(54) High production rate machine for personalization of integrated circuit modules

(76) Inventors: Stephane Medioni, Antony (FR); Simon Ormerod, Mardie (FR)

Correspondence Address: PERMAN & GREEN, 425 POST ROAD, FAIRFIELD, CT, 06824, US

(21) Appl. No.: 10/712,493

(22) Filed: Nov. 13, 2003

(30) Foreign Application Priority Data
Nov. 15, 2002 (FR) 0214325

(51) Int. Cl. G06F 7/00

(52) U.S. Cl. 700/225

(57) ABSTRACT

This invention relates to a high production rate machine for personalization (2) of integrated circuit modules (51₀, . . . , 51ₙ) fitted on a film ribbon (5) comprising:

a rotating personalization wheel with which the film ribbon is forced into contact;

means of setting up communication with the integrated circuit, at least on a portion of the rotating personalization wheel (1), and

means (61, 62, 63, 64, 65) of positioning and driving the film ribbon synchronously with rotation of the personalization wheel (1).

This invention relates to a high production rate machine for personalization of integrated circuit modules.

An integrated circuit module means an integrated circuit comprising a microprocessor associated with at least one memory or a set of memories associated with a sequencer circuit and made in an integrated circuit chip, the said integrated circuit chip being fixed to a substrate composed of a film comprising either contact areas for making the necessary connections with the integrated circuit, or antennas enabling contact free communication with the integrated circuit.

Integrated circuit card personalization machines are known that are capable of personalizing plastic cards into which modules like those described above are inserted. However these various systems process one card after the other, and cannot achieve very high production rates.

Thus U.S. Pat. No. 4,827,425 defines a card-wheel system comprising a card insertion line and a card extraction line, these lines being radial with the card-wheel and the inserted card being rotated by almost a complete turn before reaching the output. The rotation time and the size of the drum are selected such that electronic systems have time to carry out personalization operations on the card. This requires relatively large machines, considering the size of the drums that must be fairly large so as to enable the use of a large number of personalization stations. Furthermore, these operations require a relatively long time period. With this type of device, between ten and sixty seconds are necessary to program the integrated circuit, which limits personalization rates. Furthermore, since these personalization devices are large, it is difficult to include them in a continuous manufacturing line.

Similarly, patent application EP 0 256 921 relates to a card personalization system by batch, that handles a stack of cards and in which cards are inserted into personalization slits. This machine requires that displacements are controlled along two perpendicular directions and it is therefore incapable of achieving high production rates.

Finally, patent application EP 1 076 314 describes a linear personalization machine that can easily be integrated into a transfer line, and French patent 2 766 945 describes a drum personalization machine that can be arranged along a transfer line such that cards can be routed to the different manufacturing stations. However, as in previous systems, apart from the production rates that are variable, these systems have the disadvantage that the entire card-plastic-button assembly has to be scrapped if the personalization operation did not work correctly. This introduces problems in recovery of materials and retreatment of waste.

<<IBM Technical Disclosure Bulletin>>, May 1991 Vol. 33 No. 12 pages 251 to 259, also contains an article entitled <<High-Speed Opens And Shorts Substrate Tester>> that divulges a device for testing an integrated circuit substrate or printed circuit cards, to detect short circuits and non-conducting lines. This type of device uses a robot-arm that puts the substrates into the pockets of a conveyor belt, and the substrates are then carried to a test station to be placed at four points and a probe is then lowered to establish contacts with determined points on the substrate and to make the tests. When the test is complete, the tested sample is classified into one of four categories—accepted, rejected, to be reprocessed or to be retested. The test head is raised and lowered during each operation so that the sample to be tested can be inserted, and so that the test can be carried out after the head has been lowered, and finally the head is raised again after the test has been completed. This forward and backward movement of the head reduces the potential production rate of the machine, and if this rate is increased too much, can cause damage either to the contact pins on the head, or to tested areas on the sample.

The purpose of the invention is to propose a high production rate machine for the personalization of integrated circuit modules that does not have any of the disadvantages mentioned above.

This purpose is achieved with a high production rate machine for personalization of integrated circuit modules fitted on a film ribbon characterized in that it comprises:

a rotating personalization wheel against which the film ribbon is in contact;

means for establishing a communication with the integrated circuit on at least one portion of the rotating personalization wheel, and

means for positioning and driving the film ribbon synchronously with the rotation of the personalization wheel.

According to another feature, the ribbon driving and positioning means consist of two pin wheels and a contact belt surrounding at least the rotating personalization wheel.

According to another feature, the personalization wheel is polygonal.

According to another feature, the means for establishing a communication with the integrated circuit are formed when the film ribbon comprises a contact area setting up connections, between a part of the surface of the film and the integrated circuit by contact pins, or when the film ribbon comprises one or more antennas on one of its faces, capable of establishing a communication with the integrated circuit through one or more antennas formed in the connection head placed in said portion of the personalization wheel.

According to another feature, the personalization wheel comprises one or more communication heads placed at regular intervals on the personalization wheel, the distance between the communication heads corresponding to the distance between the communication means made on the film ribbon and associated with two different integrated circuits.

According to another feature, the personalization wheel can be extracted so as to quickly match the typology of the film or the pitch between the modules containing integrated circuits.

According to another feature, the machine comprises electronic cards connected through a link adapted to connection heads.

According to another feature, the connection heads are hybrid connection heads.

According to another feature, the connection heads are of the contact type.

According to another feature, the connection heads are of the no-contact type.

According to another feature, the personalization wheel comprises an eccentric fixed cam free to rotate about the drum.

According to another feature, the connection heads are mounted on assemblies mobile in the radial direction.

According to another feature, the connection heads are, retracted during the period in which there is no contact and remain retracted until contact is made again.

According to another feature, each electronic card is connected through an interface to a rotating connector and through a serial communication link to a computer managing all personalizations, sending personalization parameters towards each module and the production process on the output side of personalization as a function of tests carried out during personalization to determined whether the personalized module can be used or should be scrapped.

According to another feature, the machine includes a test card to test each personalized module at the end of the personalization cycle, to determine whether the personalized module can be used or should be scrapped.

The other purpose of the invention is to propose a process for manufacturing integrated circuit module cards to increase production rates and to reduce scrap.

This purpose is achieved with a process for manufacturing cards containing an integrated circuit module including a high production rate machine for making integrated circuits according to one of the above claims, followed by a station for cutting out modules containing integrated circuits and a station for routing modules to a station for inserting modules in plastic cards provided with a module insertion recess.

According to another feature, the cut out module is sent towards a scrap station.

According to another feature, the production line for plastic cards comprises a step for personalizing the plastic by etching or embossing or printing personalization information corresponding to personalization information defined in one of the integrated circuits, a step for identifying the integrated circuit comprising determined personalization information and a step for determining the personalization to be made on the plastic as a function of progress of the module containing the integrated circuit so that the integrated circuit is inserted in the plastic containing the corresponding personalization.

According to another feature, the process comprises the plastic personalization step after insertion of the personalized module into the plastic.

Other specific features and advantages of this invention will become clearer after reading the following description in which:

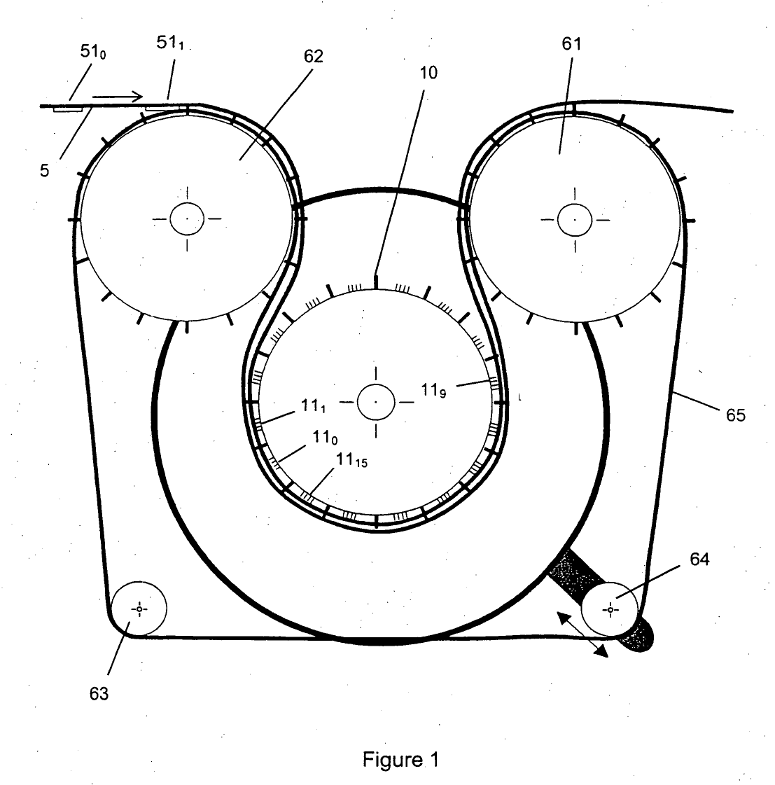

FIG. 1 shows a front elevation view of the personalization machine;

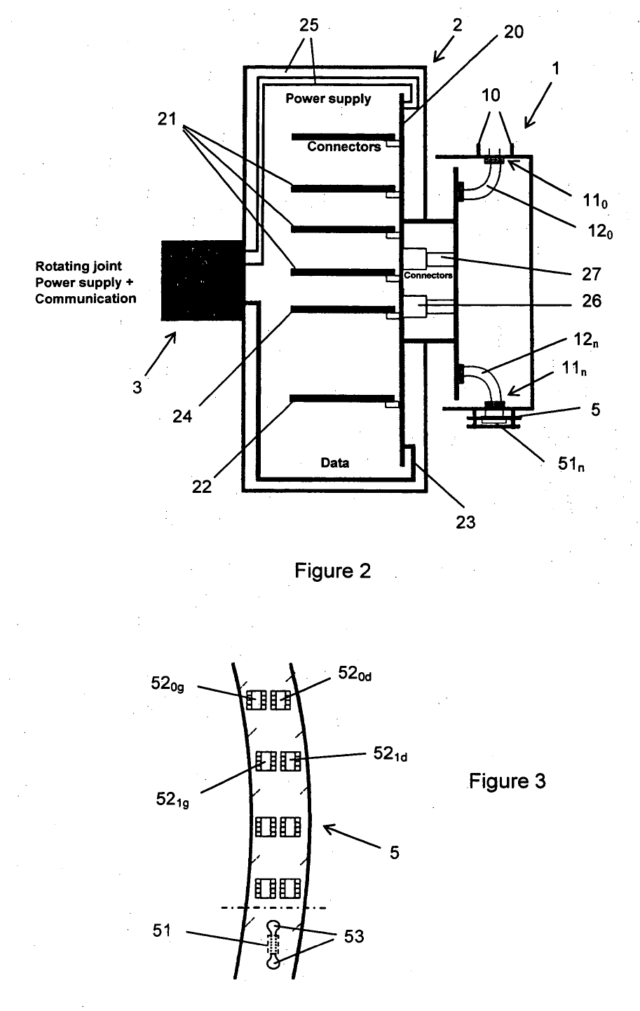

FIG. 2 shows a side view of cutout cards 1 to n of the personalization machine;

FIG. 3 shows a top view of the films used by the personalization machine;

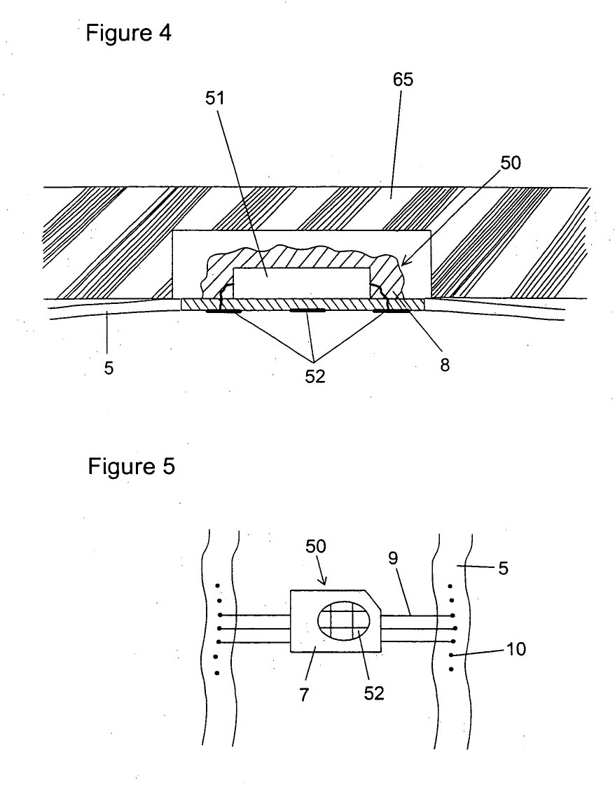

FIG. 4 shows a diagrammatic view of how the belt forces the film into contact with the personalization wheel;

FIG. 5 shows a diagrammatic view of the connection of a SIM card to the film ribbon;

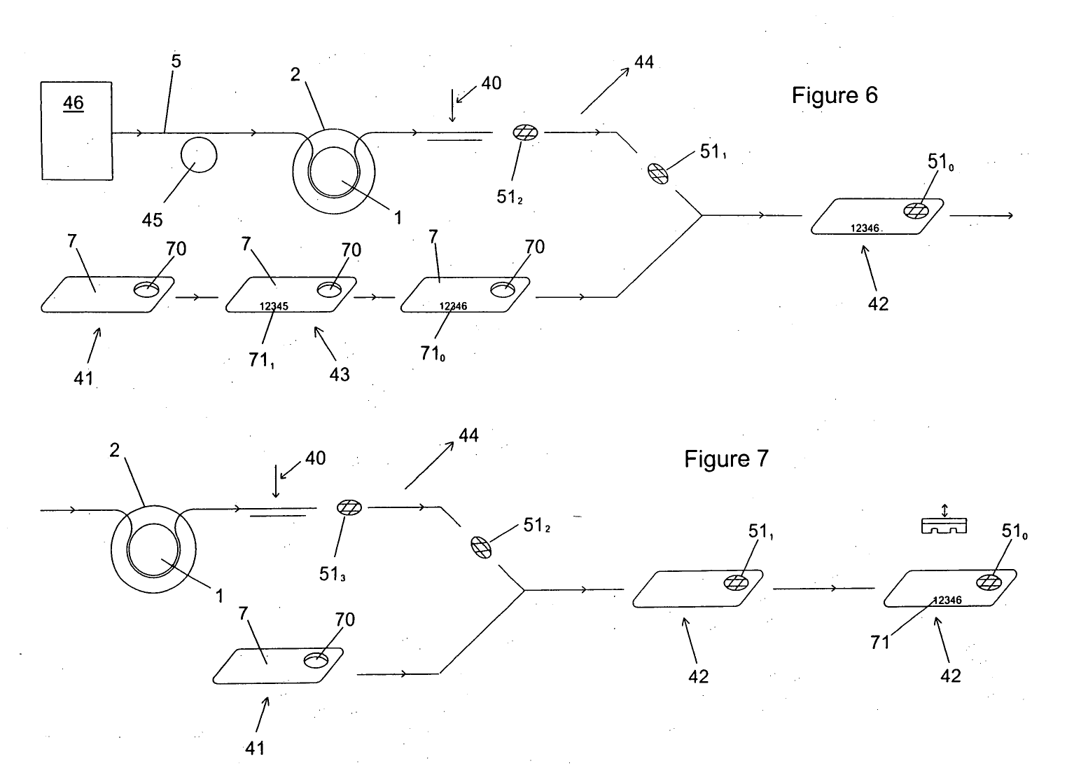

FIG. 6 shows a diagrammatic view of an in-line manufacturing process using a high production rate machine for personalization of modules;

According to a first variant embodiment, FIG. 7 shows a second embodiment of a production line using a personalization machine according to the invention.

We will now describe the invention using FIGS. 1 to 6.

The invention is particularly useful to personalize chips or integrated circuits, and particularly modules in which the integrated circuit is associated with a means of connecting the integrated circuit to the outside world. This connection means consists either of contacts in which each contact area is connected by conductors to the inputs of the integrated circuit, or by one or several antennas to create a contact free communication by radio waves or electromagnetic waves with another antenna connected to a terminal or to a machine. The module may also be hybrid and comprise a connection means with contact to the outside world and/or a no-contact connection means to the same outside world. The modules (50) are usually composed of an association of integrated semiconductor circuits (51₀, . . . , 51ₙ) covered with resin (8) fixed to one face of a flexible film (5), and the other face of the film may for example contain contact areas (52), these contact areas (52) being connected to the integrated circuit through connection wires or solder beads or any other means. This makes a module with contact connections (50). The film can also include one or several antennas on one face connected by electrical means to some inputs of the integrated circuit to form either a hybrid module if the module also comprises a contact connection, or a no-contact module if it does not comprise any contact connections. Since the buttons (50) are small enough, there are usually two parallel tracks of contact areas (52_{0d}, 52_{1d}, 52_{0g}, 52_{1g}) placed on a film. The modules (50) thus made are then cut out by a cutting machine (40, FIG. 6) to be inserted into plastic supports the size of a credit card to form smart cards, used to deliver bank or social security services, or into plastic supports in which a part can be broken off to form a SIM module used in the mobile telephone industry to create a security means for the mobile telephone and the connection.

The film (5) carrying the modules (50), is transferred by a conveyance means (45, FIG. 6) from the output of a chips insertion machine (46) on the film towards the input of the personalization machine shown in FIG. 1.

The personalization machine (2) is composed of at least one drum (1) with a smaller diameter than a second drum or casing (2) containing electronic management and interfacing circuits of connection heads (11₀, . . . , 11ₙ) attached to the periphery of the drum (1) such that the connectors composed of several pins fitted on elastic means can come into contact with contact areas on the film (5) and such that the antennas (not shown) of these connection means (11₀, . . . , 11ₙ) can set up a link with the antennas (53) of the module (50) formed on the film. As can be seen in FIG. 1, the connection head wheel comprises several connection heads (11₀, . . . , 11ₙ) and its diameter is selected as a function of the size of the modules (50), but it is much smaller than the normal diameter of personalization machines like those defined by prior art in U.S. Pat. No. 4,627,425 or patent FR 2 766 945. The personalization machine (2) also comprises a means (61, 62, 63, 64, 65) of forcing the film into contact with the module (50) oriented relative to the connection head wheel such that the integrated circuits (51) each come into communication with a connection head (110, . . . , 11n) of the personalization wheel along a path that is partially common with the path of the personalization wheel and is sufficiently long so that the integrated circuit can be personalized during this contact phase. Thus, non-limitatively, as shown in FIG. 1, the integrated circuit (51₁) comes into contact with the connection head (11₁), will follow rotation of the head until the connection head (11₁) has reached the position corresponding to the connection head (11₉) in FIG. 1. At this moment, the contact or the electrical connection between the integrated circuit and the connection head will be interrupted. The means of making the link and the synchronous displacement of the film with the connection head may for example be composed of pins (10) fitted on the wheel of the connection head and a belt (65) tensioned by an adjustable tension wheel (64) so that the film is forced into contact with a sufficient force for the pins in the contact connection heads to come into contact and give a good electrical connection. Obviously, this embodiment is not limitative and it would be quite possible to envisage an embodiment in which the pins are eliminated and the drive is provided simply by friction by creating a contact pressure between the film and the belt (65), which as shown in FIG. 4, is provided with cavities and overthicknesses to absorb the thickness of the integrated circuit (51) and the resin (8), on the personalization wheel, the pressure being sufficiently high to prevent the integrated circuit (51) from slipping with respect to the connection heads (11). In another embodiment, a cam could be integrated into the personalization wheel. This cam is fixed and is eccentric, and is free to rotate about the drum (1). The connection heads (11₀, . . . , 11ₙ) are then mounted on assemblies mobile in the radial direction and are therefore loaded by elastic means near the rotation axis to adapt to the profile of the cam. In the embodiment in FIG. 1, it will be seen that the wheels (62, 61) are used to drive the film and also to synchronously drive the film contact belt. The pins have the advantage that they enable good centering of the film and consequently the modules (50) with respect to the position of the connection heads (11₀, . . . , 11ₙ), onto the personalization wheel. As in the other personalization machines, each connection head (11₀, . . . , 11ₙ) is connected by conductors (12₀, . . . , 12ₙ) to a main printed circuit card (20) to which other control and testing cards (21) for each of the connection heads (11₀, . . . , 11ₙ) are connected. Each of the cards (21) controls one or several connection heads (11₀, . . . , 11ₙ) and receives data through a bus (23) connected firstly to the bus of the main card (20) and secondly to a rotating joint (3) to which the power supply for the assembly is connected and which receives communication of serial information from a data processing system managing personalization of the production line. The rotating joint (3) also supplies a power supply through conductors (25) to the electronic assembly composed of the cards (21, 22) and the connection heads. A card (22) is used to test the module with contact connections or the no-contact module and assures that personalization was done correctly and that the module (50) is operational, before the module has left the area in which it was connected to the personalization head. Finally, the electronic casing of the personalization machine may also comprise a security memory card (24) called the mother card, the function of which is to provide security information necessary for personalization. The machine also comprises a system for counting and marking each module, to send information to a central management system for the production line as a function of the personalization results obtained by the test card (22), and this central management system will determine if the integrated circuit (for example 512 in FIG. 6) should be scrapped (44). In the embodiment in FIG. 2, the first casing (1) and the second casing (2) are cylindrical and are driven in rotation, and form the communication link with the computer production line management system, setting up a serial link with a rotating joint (3). However, since the technology can change, it could be envisaged to allow the fixed heads control box to create a rotating link between the control box (2) and the rotating head (1). In this case, the rotating head (1) would simply incorporate a circuit for serialization and preparation of information circulating between the rotating heads and the electronic management circuits contained in the casing. Another embodiment proposes assembly methods so that wheels can be extracted. The wheel (1) connects directly onto the female connectors (27). Therefore, the use of male and female connectors (26 and 27) facilitates disconnection of the wheel (1) so that another wheel can be used instead.

The personalization machine shown in FIGS. 1 and 2 could be used in a production line for portable cards including an integrated circuit (51) according to the variant in FIG. 6 by including a forming station (41) for plastic supports (7) provided with a compartment (70) designed to hold the module (50). The line continues with an embossing or a printing station (43), to mark visible information (71₀, 71₁) on the plastic, corresponding to the information written on each of the modules (51₀, 51₁). Thus, after the module in which the integrated circuit (51₀) is fitted has been cut out (40), it will be associated with the card carrying the information (71₀). Therefore, the plastic supports production line comprises a system for counting and identifying the position of objects, for supplying the personalized plastic synchronously with the personalized button carrying information corresponding to information carried by the plastic. The button or module in which the integrated circuit (51₀) is fitted is then inserted in the recess (70) in the plastic support (7) at the station (42) by an operation that is routine for those skilled in the art.

Another embodiment of the invention is shown in FIG. 7. In this mode, the plastic supports (7) are directly associated with the modules at the output from the cutout operation (40) and the operation to eliminate scrap (44), the production line comprising a system for identifying each of the modules so as to be able to carry out personalization (43) of the plastic corresponding to personalization received by the module inserted in the card, after the insertion station (42).

Another embodiment of the invention is shown in FIG. 5. This figure shows the connection of micro SIM cards to the film ribbon (5) before they pass through the personalization wheel (1). This connection is made through links made of a material that cannot be broken off.

Obviously, those skilled in the art will realize that this invention can be used for many other specific embodiments without departing from the scope of the invention as claimed. Consequently, these embodiments must be considered for illustrative purposes, but they can be modified within the field defined by the scope of the appended claims, and the invention must not be limited to the details given above.

1. High production rate machine for personalization (2) of integrated circuit modules (51₀, . . . , 51ₙ) fitted on a film ribbon (5) characterized in that it comprises:
a rotating personalization wheel against which the film ribbon is in contact;
means for establishing a communication with the integrated circuit (51) on at least one portion of the rotating personalization wheel (1), and
means for positioning and driving (61, 62, 63, 64, 65) the film ribbon (5) synchronously with the rotation of the personalization wheel (1).

2. Machine according to claim 1, characterized in that the ribbon (5) driving and positioning means (61, 62, 63, 64, 65) consist of two pin wheels (61, 62) and a contact belt (65) surrounding at least the rotating personalization wheel (1).

3. Machine according to claim 1 or 2, characterized in that the personalization wheel (1) is polygonal.

4. Machine according to claim 1 or 2, characterized in that the means for establishing a communication with the integrated circuit (51) are formed when the film ribbon (5) comprises a contact area (52) setting up connections between a part of the surface of the film and the integrated circuit (51) by contact pins, or when the film ribbon (5) comprises one or more antennas on one of its faces (52), capable of establishing a communication with the integrated circuit (51) through one or more antennas formed in the connection head (11) placed in said portion of the personalization wheel (1).

5. Machine according to claim 4, characterized in that the personalization wheel (1) comprises one or more communication heads (11₀, . . . , 11ₙ) placed at regular intervals on the personalization wheel (1), the distance between the communication heads corresponding to the distance between the communication means made on the film ribbon (5) and associated with two different integrated circuits (51ₙ).

6. Machine according to claim 4 or 5, characterized in that the personalization wheel (1) can be extracted so as to quickly match the typology of the film (5) or the pitch between the modules containing integrated circuits (51).

7. Machine according to claim 4 or 5, characterized in that the machine comprises electronic cards (21) connected through a link adapted to connection heads (11₀, . . . , 11ₙ).

8. Machine according to one of claims 4 to 7, characterized in that the connection heads (11₀, . . . , 11ₙ) are hybrid connection heads.

9. Machine according to one of claims 4 to 7, characterized in that the connection heads (11₀, . . . , 11ₙ) are of the contact type.

10. Machine according to one of claims 4 to 7, characterized in that the connection heads (11₀, . . . , 11ₙ) are of the no-contact type.

11. Machine according to one of claims 4 to 7, characterized in that the personalization wheel (1) comprises an eccentric fixed cam free to rotate about the drum.

12. Machine according to one of claims 4 to 11, characterized in that the connection heads (11₁, . . . , 11ₙ) are mounted on assemblies mobile in the radial direction.

13. Machine according to one of claims 4 to 12, characterized in that the connection heads (11₀, . . . . , 11ₙ) are retracted during the period in which there is no contact and remain retracted until contact is made again.

14. Machine according to one of claims 7 to 13, characterized in that each electronic card is connected through an interface to a rotating connector and through a serial communication link to a computer managing all personalizations, sending personalization parameters towards each module and the production process on the output side of personalization as a function of tests carried out during personalization to determined whether the personalized module can be used or should be scrapped.

15. Machine according to one of claims 1 to 14, characterized in that the machine includes a test card (22) to test each personalized module at the end of the personalization cycle, to determine whether the personalized module can be used or should be scrapped.

16. Process for manufacturing cards containing an integrated circuit module including a high production rate machine (1) for making integrated circuits (51₀, . . . , 51ₙ) according to one of the above claims, followed by a station (40) for cutting out modules containing integrated circuits and a station for routing modules to a station (42) for inserting modules in plastic cards (7) provided with a module insertion recess.

17. Process according to claim 16, characterized in that the cut out module (50) is sent towards a scrap station (44).

18. Process according to claim 16 or 17, characterized in that the production line for plastic cards comprises a step for personalizing (43) the plastic by etching or embossing or printing personalization information (71₀, . . . , 71ₙ) corresponding to personalization information defined in one of the integrated circuits (51₀, . . . , 51ₙ), a step for identifying the integrated circuit comprising determined personalization information and a step for determining the personalization to be made on the plastic as a function of progress of the module containing the integrated circuit so that the integrated circuit is inserted in the plastic containing the corresponding personalization.

19. Process according to claim 18, characterized in that it comprises the plastic personalization step (43) after insertion (42) of the personalized module into the plastic (7).
